(19) United States
(12) Patent Application Publication
(10) Pub. No.: US 2016/0251209 A1
(43) Pub. Date: Sep. 1, 2016

(54) HOLDER FOR A LIQUID PRODUCT

(71) Applicant: CARDIFF GROUP, NAAMLOZE VENNOOTSCHAP, Zonhoven (BE)

(72) Inventor: Geert Norbert R. STANDAERT, Zonhoven (BE)

(73) Assignee: CARDIFF GROUP, NAAMLOZE VENNOOTSCHAP, Zonhoven (BE)

(21) Appl. No.: 15/027,379

(22) PCT Filed: Oct. 3, 2014
(86) PCT No.: PCT/BE2014/000053

§ 371 Date: Apr. 5, 2016

(30) Foreign Application Priority Data
Oct. 8, 2013 (BE) 2013/0671

(51) Int. Cl. B67D 1/04; B67D 1/08

(52) U.S. Cl. CPC B67D 1/0462; B67D 1/0801; B67D 2001/0822; B67D 2210/00002

(57) ABSTRACT

Holder (1) to keep a fluid product (12) under pressure and to let it flow out under pressure, whereby the holder (1) includes a rigid outer holder (3) and a flexible inner holder (5), whereby the inner holder (5) and the outer holder (3), or the inner holder (5) and a flexible intermediate holder (4) between the inner holder (5) and the outer holder (3), define a space (9) for a pressure medium, characterized in that there is a quantity of an oxygen scavenger (11) in the space (9).

The present invention relates to a holder for a fluid product.

More specifically the invention relates to a holder for beer in which the beer is kept under pressure and from which the beer is dispensed under pressure, by means of a pressure medium and a draw-off tap.

This can concern, for example, beer kegs for home use and use in cafes, from which beer can be tapped for the purpose of consuming beer. Similarly they can also be holders for other drinks such as soft drinks, wine, milk or drinks based thereon, fruit juice, or thick fluid foodstuffs such as yoghurt, mayonnaise and other sauces.

Such a beer keg must satisfy a number of technical requirements. Firstly the beer must be very well separated from the outside air, on the one hand to prevent CO2 escaping from the beer whereby the flavour of the beer would otherwise change, and on the other hand to prevent oxygen from the air getting into the beer because this can greatly affect the flavour detrimentally. For example, depending on the type, an oxygen content of 1000 ppb (parts per billion) can harm the flavour.

Such a separation from air is important before the foodstuff is used for the first time, as well as after a proportion, of the foodstuff has already been dispensed, but a proportion to be dispensed in the future is still present in the holder.

The extent to which a beer keg satisfies these technical requirements depends on the permeability to gas of the various walls that are used in the beer keg, whereby walls with a higher diffusion barrier cost more because they are thicker or make use of a more expensive material.

Secondly the holder has a mechanical function to withstand the internal pressure, without deformation or damage, that is necessary to dispense the foodstuff from the holder.

It goes without saying that such beer kegs also have to be produced as cheaply as possible, certainly because they are only intended to be used once, and also because they are intended for relatively small quantities so that the keg constitutes a relatively large proportion of the total cost.

Such beer kegs, in which a double flexible holder in rigid but relatively cheap gas-permeable outer holder is used, are published in WO 2012/167333 and WO 2013/086587 for example. In order to obtain beer from the keg, pressure is applied by means of CO2 in the space between a flexible inner holder and a flexible intermediate holder, such that the inner holder is pressurised and the beer can flow out of the keg.

However, such holders only provide a relatively limited shelf life for the beer, especially because the films used for the flexible holders are somewhat permeable to oxygen.

A relatively critical component of the known beer kegs relating to oxygen permeability is also the presence of a valve system or a connection for this purpose, so that even with the use of the best materials for the flexible holders a certain diffusion of oxygen is inevitable.

It is also known from EP1947029 and WO2011/002295 to incorporate an oxygen scavenger in a plastic holder.

This has disadvantages because the oxygen scavenger can come into contact with the beer and degrade the other properties of the plastic. There is thus only a small choice of oxygen scavengers that satisfy the preconditions that they have no effect on the consumability of the beer and have no significant effect on the other properties of the plastic.

Moreover, in this way only a limited quantity of oxygen scavenger can be used and thus can only absorb a limited quantity of oxygen.

The purpose of the present invention is to provide a solution to the aforementioned and other disadvantages by providing a holder to keep a fluid product under pressure and to let it flow out under pressure, whereby the holder comprises a rigid outer holder and a flexible inner holder, whereby the inner holder and the outer holder, or the inner holder and a flexible intermediate holder between the inner holder and the outer holder, define a space for a pressure medium, whereby there is a quantity of an oxygen scavenger in the said space.

Such an oxygen scavenger is a chemical product that easily reacts with oxygen, even in small quantities, so that the oxygen from the environment is bound in a chemical reaction product. The most well known product of this type is iron powder.

In this way the quantity of oxygen that can reach the fluid product, and which can have undesired effects on the fluid product, is reduced. The small quantity of oxygen that diffuses through the outer holder and/or the flexible intermediate holder and/or a valve system and/or connection thereto is removed by the oxygen scavenger before this oxygen can diffuse through the inner holder and get into the product in the inner holder.

This gives a longer shelf life with the same construction of the intermediate holder and inner holder.

Alternatively for a more or less equal shelf life, a thinner and/or cheaper construction of the intermediate holder and/or inner holder can be used.

For clarity it is noted that the quantity of oxygen scavenger is in the said space and is not incorporated in the material from which the inner holder and/or outer holder and/or intermediate holder is made.

A further advantage is that a much larger choice of oxygen scavengers is possible, that the beer cannot come into contact with the oxygen scavenger, and that there are no technical effects of the oxygen scavenger on the plastic.

Moreover, a much larger quantity of oxygen scavenger can be used in the holder than with the traditional technology.

The said space comprises all other volumes that are in open connection with it and are thus freely accessible for the gas in the said space. These volumes do not necessarily have to be between the inner holder and the outer holder or intermediate holder, but can be in a valve system affixed to the holder for example.

The quantity of oxygen scavenger is preferably such that it can bind the quantity of oxygen that can permeate through the outer holder and, if present, the intermediate holder for two years, when the outer holder is surrounded by air.

This quantity can easily be calculated by a person skilled in the art from the area of the oxygen-permeable intermediate holder or outer holder, and the permeability to oxygen thereof that can be determined experimentally in standardised conditions.

In a preferred embodiment there is a pressure medium in the said space to pressurise the inner holder and any product contained therein, whereby the pressure medium is nitrogen.

Such a situation occurs in particular before such a holder is filled with product. A filling installation for beer, for example, works best if there is a counterpressure. This also prevents the beer from foaming during filling.

For this reason pressure is placed on a holder upon its production. Traditionally CO2 is used for this. However, according to the preferred embodiment it is useful to use nitrogen for this purpose, because nitrogen diffuses through most materials more slowly than CO2, including materials used for the outer holder and for the flexible holder or holders, so that an applied pressure is maintained for longer and the possible storage time of the holders before being filled is thereby increased. Nitrogen is also cheaper than CO2, because nitrogen can be generated easily and cheaply from air according to need, and CO2 requires expensive refrigerated storage.

As a result the oxygen scavenger is at least partially protected against contact with airborne oxygen, so that it is not partly or entirely consumed before the holder is filled with product.

Such a situation also occurs if the holder is filled with product, but before a supplementary quantity of pressure medium, for example CO2, is provided from a pressure cylinder.

The invention further concerns the use of an oxygen scavenger in a space for a pressure medium in a holder for keeping a fluid product pressurised and letting it flow out under pressure, in order to keep this space free of oxygen.

With the intention of better showing the characteristics of the invention, a preferred embodiment of a holder according to the invention is described hereinafter by way of an example, without any limiting nature, with reference to the accompanying drawings, wherein:

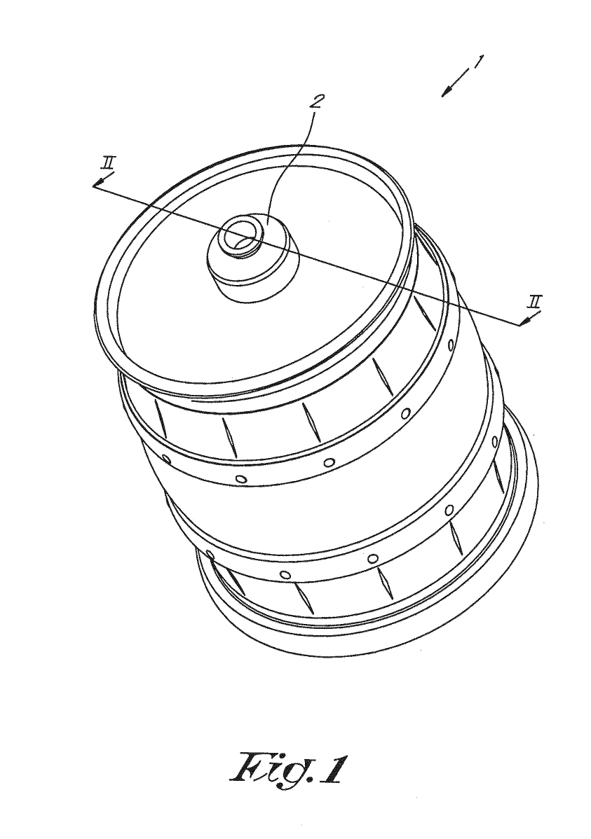

FIG. 1 schematically shows a perspective view of a holder according to the invention;

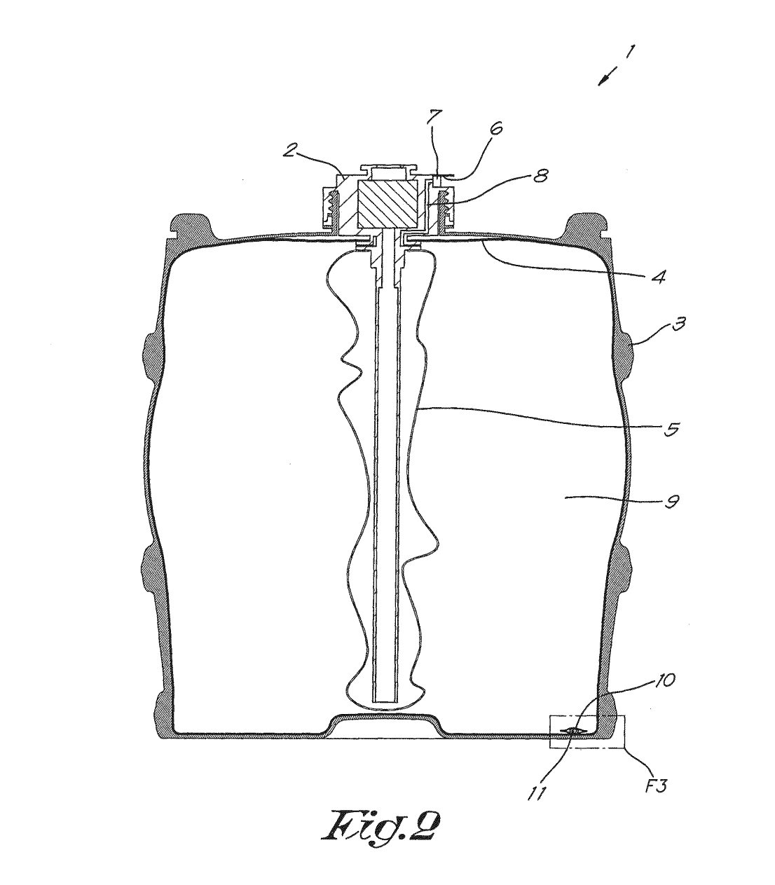

FIG. 2 shows a cross-section of the holder of FIG. 1 according to II-II in a first usage situation;

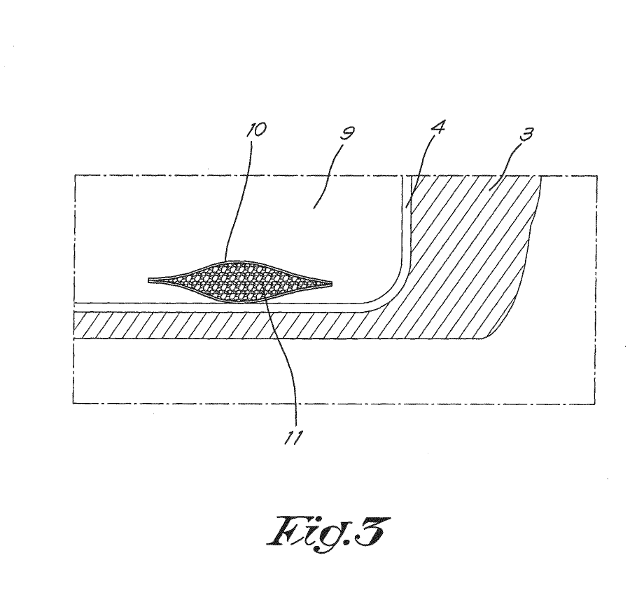

FIG. 3 shows the part of FIG. 2 indicated by F3 on a larger scale;

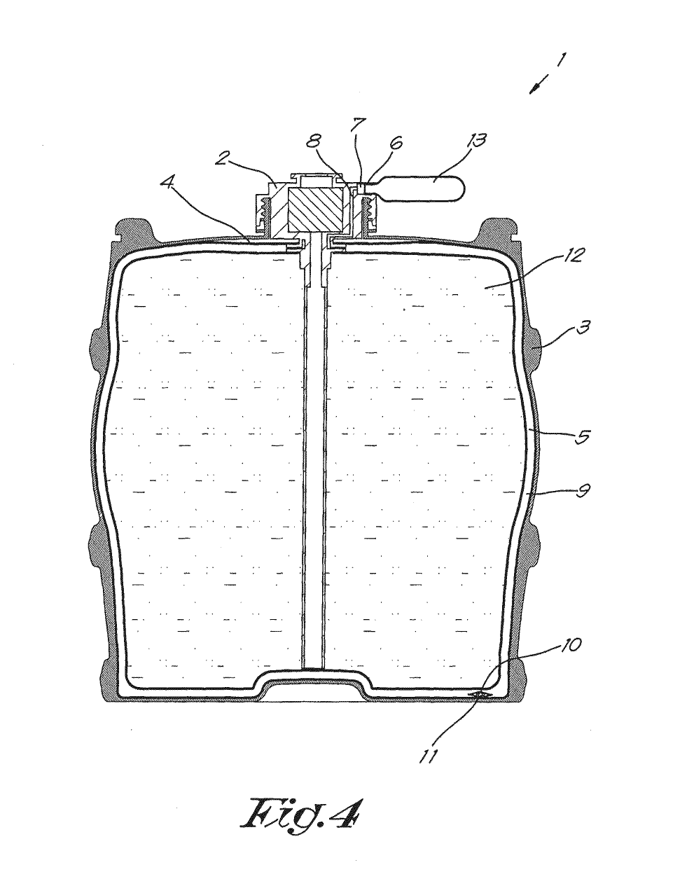

FIG. 4 shows a cross-section of the holder of FIG. 1 as shown in FIG. 2 in a second usage situation.

The holder shown in the drawings is a beer keg 1 that is provided with a valve system 2, not shown in detail, with a valve that is provided so that a draw-off tap connected thereto can be opened to let beer flow out of the beer keg 1.

The beer keg is a three-layer construction. The outermost layer is formed by an outer holder 3 of rigid polyethylene. Polyethylene is relatively strong, can easily be formed and is relatively cheap, but has a high permeability to gases.

Hence a flexible intermediate holder 4 is affixed in the outer holder 3 that is made of a film with a high resistance to gas diffusion. A flexible inner holder 5 is affixed within the intermediate holder 4 that is made of the same film.

The valve system 2 is also provided with a connection 6 for a CO2 cartridge, whereby this connection 6 is provided with a combined non-return/overpressure valve 7 that enables gas to flow into a passage 8, but only when the pressure in the passage 8 is above a certain limiting pressure can gas flow out of the passage 8 to the outside.

The passage 8 is connected to the space between the inner holder and the outer holder and together thereby form a single space 9 for a gas.

A paper bag 10 is placed in this space 9 in which there is a powdered oxygen scavenger 11 in the form of 10 grams of iron powder with additives such as active carbon, vermiculite, diatomaceous earth, NaCl and water.

The first usage situation of the beer keg shown in FIG. 2 is the first usage situation after production of the beer keg 1.

In this first usage situation the space 9 defined by the inner holder and the intermediate holder, and of course every other volume that has an open connection thereto, is filled with nitrogen so that there is a pressure of approximately 2 bar in the beer keg 1.

This filling can be done via the connection 6 for the CO2 cartridge and the passage 8, but the valve system 2 can also be provided with another passage for this purpose.

The majority of the nitrogen is kept in the said space for a long time due to the low permeability to nitrogen of the inner holder 5 and the intermediate holder 4, so that the counterpressure required for the automated filling of the beer keg 1 with beer is present.

The nitrogen under overpressure in the said space 9 also prevents the free inflow of air, so that the oxygen scavenger 11 does not yet come into contact with oxygen to then react with it, and thus remains active.

The beer keg 1 can now be stored for some time without any problems before being filled with beer.

The inner holder 5 can then be filled with beer 12 via the valve system 2. The pressure in the space 9 with nitrogen will thereby rise, such that the non-return/overpressure valve 7 between the connection 6 and the passage 8 is opened so that this nitrogen can largely escape. The remaining nitrogen in this space 9, which has the same pressure as the CO2 pressure in the beer 12, continues to fulfil the above-mentioned functions and also prevents the escape of CO2 from the beer 12 by diffusion through the inner holder 5.

As a result flavour problems with the beer 12 due to the escape of CO2 are prevented or limited.

During the storage period of the filled beer keg 1 oxygen will easily diffuse from the air through the outer holder 3. The outside of the intermediate holder 4 will thus be exposed to a relatively oxygen-rich gas mixture.

Despite the fact that the intermediate holder 4 has a relatively low permeability to oxygen, some oxygen can nevertheless diffuse into the space 9 between the intermediate holder 4 and the inner holder 5. However, this oxygen, before it can diffuse through the inner holder 5 and affect the flavour of the beer 12, is removed from the gas in this space 9 by the oxygen scavenger 11 and converted into a non-volatile reaction product, i.e. iron oxide, whereby the paper bag 10 will not form a barrier for the oxygen in practice.

When the beer keg 1 has to be used, as shown in FIG. 4, a CO2 cartridge 13 is connected to the connection so that the CO2 present therein can flow to the space 9 between the inner holder 5 and the intermediate holder 4 and can keep the pressure on the inner holder 5 high enough, even when the inner holder 5 has been largely tapped empty. A draw-off tap, not shown in FIG. 4, is also connected to the valve system 2.

The location of the oxygen scavenger 11 shown is only given as an example. It can be affixed anywhere in the space between the inner holder 5 and the intermediate holder 4, but can also be affixed in the valve system 2, in particular in the passage 8 that leads from this space to the connection 6 for the CO2 cartridge 13. Preferably the oxygen scavenger is placed at a location where the greatest permeability of the beer keg 1 is expected, for example close to connections and/or seams.

As an alternative to a CO2 cartridge 13, other pressure media can also be used to pressurise the inner holder 5. These pressure media can also be present, partly or completely permanently, in the beer keg 1, more specifically the valve system 2, as of the moment that the beer keg 1 is filled, as published in WO 2013/086587.

Although described above as a beer keg, a holder according to the invention with advantages for any oxygen-sensitive fluid product can be used, such as for example adhesives, spray fluid, etc.

The present invention is by no means limited to the embodiment described as an example and shown in the drawings, but a holder according to the invention can be realised in all kinds of forms and dimensions without departing from the scope of the invention.

1. Holder (1) to keep a fluid product (12) under pressure and to let it flow out under pressure, whereby the holder (1) comprises a rigid outer holder (3) and a flexible inner holder (5), whereby the inner holder (5) and the outer holder (3), or the inner holder (5) and a flexible intermediate holder (4) between the inner holder (5) and the outer holder (3), define a space (9) for a pressure medium, and wherein there is a quantity of an oxygen scavenger (11) in the space (9).

2. Holder according to claim 1, further comprising a flexible intermediate holder (4) that is between the inner holder (5) and the outer holder (3), whereby the oxygen scavenger (11) is in the space (9) that is defined by the inner holder (5) and the intermediate holder (4).

3. Holder according to claim 1, wherein the oxygen scavenger (11) is in one or more packages (10) permeable to oxygen.

4. Holder according to claim 1, wherein the quantity of oxygen scavenger (11) is such that it can bind the quantity of oxygen that can permeate through the outer holder (3) and, if present, the intermediate holder (4), for two years when the outer holder (3) is surrounded by air.

5. Holder according to claim 1, wherein the oxygen scavenger at least partly consists of iron powder.

6. Holder according to claim 1, wherein there is a pressure medium in the space (9) to pressurize the inner holder (5), and any product (12) therein, whereby the pressure medium is nitrogen.

7. Holder according to claim 1, wherein the holder is configured to hold fluid foodstuff (12).

8. Holder according to claim 1, wherein the inner holder (5) contains a fluid foodstuff (12).

9. Holder according to claim 7, wherein the fluid foodstuff is beer (12).

10. Holder according to claim 1, wherein the inner holder (5) contains a non-edible fluid product.

11. Method of preventing oxygen from getting into a fluid product which comprises placing an effective amount of an oxygen scavenger (11) in a space (9) for a pressure medium in a holder (1) for keeping the fluid product (12) pressurized and letting said oxygen scavenger flow out under pressure, in order to keep said space (9) free of oxygen.

12. The method according to claim 11, wherein the fluid product is beer (12).

13. The method according to claim 11, wherein the fluid product is not edible.

14. The method according to claim 11, wherein the quantity of oxygen scavenger (11) is in one or more packages permeable to oxygen (10).

15. The method according to claim 11, wherein the quantity of oxygen scavenger (11) is such that it can bind the quantity of oxygen that can penetrate into the space (9) for two years.
